(19) United States
(12) Patent Application Publication
(10) Pub. No.: US 2017/0229886 A1
(43) Pub. Date: Aug. 10, 2017

(54) Digital Electricity Transmission System using Reversal Sensing Packet Energy Transfer

(71) Applicant: VoltServer, Inc., East Greenwich, RI (US)

(72) Inventor: Stephen S. Eaves, Charlestown, RI (US)

(73) Assignee: VoltServer, Inc., East Greenwich, RI (US)

(21) Appl. No.: 15/426,982

(22) Filed: Feb. 7, 2017

Related U.S. Application Data
(60) Provisional application No. 62/292,596, filed on Feb. 8, 2016.

(51) Int. Cl. H02J 7/00; H02J 3/14; H02J 9/06; H02J 13/00

(52) U.S. Cl. CPC H02J 7/0034; H02J 13/0017; H02J 3/14; H02J 9/061

(57) ABSTRACT

In the transfer of energy from a source to a load, a power distribution system is configured to detect unsafe conditions that include electrically conducting foreign objects or individuals that have come in contact with exposed conductors in the power distribution system. A responsive signal is generated in a source controller including source terminals. The responsive signal reverses a voltage on the source terminals. With the voltage on the source terminals reversed, a measurement of electrical current flowing through the source terminals is acquired; and the source controller generates signals to electrically disconnect the source from the source terminals if and when the electrical current falls outside of high or low limits indicating that there is a conducting foreign object or living organism making electrical contact with the source or load terminals or a failure in power distribution system hardware.

### RELATED APPLICATION

This application claims the benefit of U.S. Provisional Application No. 62/292,596, filed 8 Feb. 2016, the entire content of which is incorporated herein by reference.

### FIELD OF INVENTION

This invention relates to power distribution system safety protection devices—for example, power distribution systems with electronic monitoring to detect and disconnect power in the event of an electrical fault or safety hazard, particularly where an individual has come in contact with exposed conductors. This invention is applicable to general power distribution, or more specifically to, e.g., electric vehicle charging, telecommunications or alternative energy power systems.

### BACKGROUND

Digital electric power, or digital electricity, can be characterized as any power format where electrical power is distributed in discrete, controllable units of energy. Packet energy transfer (PET) is a new type of digital electric power protocol disclosed in U.S. Pat. No. 8,781,637 (Eaves 2012).

The primary discerning factor in a digital power transmission system compared to traditional, analog power systems is that the electrical energy is separated into discrete units; and individual units of energy can be associated with analog and/or digital information that can be used for the purposes of optimizing safety, efficiency, resiliency, control or routing.

As described by Eaves 2012, a source controller and a load controller are connected by power transmission lines. The source controller of Eaves 2012 periodically isolates (disconnects) the power transmission lines from the power source and analyzes, at a minimum, the voltage characteristics present at the source controller terminals directly before and after the lines are isolated. The time period when the power lines are isolated was referred to by Eaves 2012 as the “sample period”, and the time period when the source is connected is referred to as the “transfer period”. The rate of rise and decay of the voltage on the lines before, during and after the sample period reveal if a fault condition is present on the power transmission lines. Measurable faults include, but are not limited to, short circuit, high line resistance or the presence of an individual who has improperly come in contact with the lines.

Eaves 2012 also describes digital information that may be sent between the source and load controllers over the power transmission lines to further enhance safety or provide general characteristics of the energy transfer, such as total energy or the voltage at the load controller terminals. Since the energy in a PET system is transferred as discrete quantities, or quanta, it can be referred to as “digital power” or “digital electricity”.

### SUMMARY

A power distribution system regulates transfer of energy from a source on a source side to a load on a load side, wherein the source and load each include terminals. A source controller on the source side is in communication with and responsive to a source sensor that provides feedback to the source controller that includes at least a signal indicative of electric current through the source terminals. A source switching bridge is electrically coupled with the source controller and is responsive to control signals from the source controller for electrically disconnecting the source from the source terminals and for applying a source voltage in either a forward-polarity or reverse-polarity state relative to the source terminals. A load disconnect device is configured to electrically decouple the load from the load terminal. A logic device is implemented in at least the source controller and configured to place the source switching bridge into a reverse-polarity state and to perform at least one current measurement on the current passing through the source terminals when the source switching bridge is in the reverse-polarity state, wherein a current measurement outside of predetermined high or low limits indicates that there is a foreign object or living organism making contact with the source or load terminals or a failure in the power distribution system, and to electrically disconnect the source from the source terminals if the current measurement falls outside the predetermined high and low limits.

In the transfer of energy from a source to a load, a power distribution system is configured to detect unsafe conditions that include electrically conducting foreign objects or individuals that have come in contact with exposed conductors in the power distribution system. A responsive signal is generated in a source controller including source terminals. The responsive signal reverses a voltage on the source terminals. With the voltage on the source terminals reversed, a measurement of electrical current flowing through the source terminals is acquired; and the source controller generates signals to electrically disconnect the source from the source terminals if and when the electrical current falls outside of high or low limits indicating that there is a conducting foreign object or living organism making electrical contact with the source or load terminals or a failure in power distribution system hardware.

The apparatus and methods described herein offer an alternative form of PET using the method of periodically reversing the polarity of the transmission lines. Since the most common forms of electrical faults are polarity independent, the method allows for detection of a fault based on the load device being equipped with a uni-directional switch, such as a diode. When the polarity of the transmission lines are reversed, the flow of electrical current is inhibited by the uni-directional switch. If there is a fault on the transmission lines, such as due to a person touching the lines, electrical current will continue to flow into the fault when the transmission lines are reversed and can be detected by the source controller.

### BRIEF DESCRIPTION OF THE DRAWINGS

FIG. 1 is a block diagram of an embodiment of the safe power distribution system.

FIG. 2 is a more detailed block diagram of an embodiment of the source controller.

FIG. 3 is a diagram of a section of an embodiment of the power distribution system with the switching bridge 7 in a non-conducting state.

FIG. 4a is a diagram of a section of an embodiment of the power distribution system with the switching bridge 7 in a forward-conducting state.

FIG. 4b is a diagram of a section of an embodiment of the power distribution system with the switching bridge 7 in a reverse-conducting state,

FIG. 5a is a diagram of a disconnect device 13 constructed using a diode 39.

FIG. 5b is a diagram of a disconnect device 13 constructed using a controllable switch 38.

FIG. 6 is a diagram of an embodiment of an alternative source controller configuration that includes a modulator/demodulator 48 for communications over power lines.

FIG. 7 is a diagram of using center-tapped isolation transformers 52-55 to combine user data and power on common twisted pair cabling.

FIG. 8 is a diagram of an alternative load and load disconnect device 13 using a series string of diodes 70, 72, 74, and 76.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise defined, used or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

### I. Description of Operation

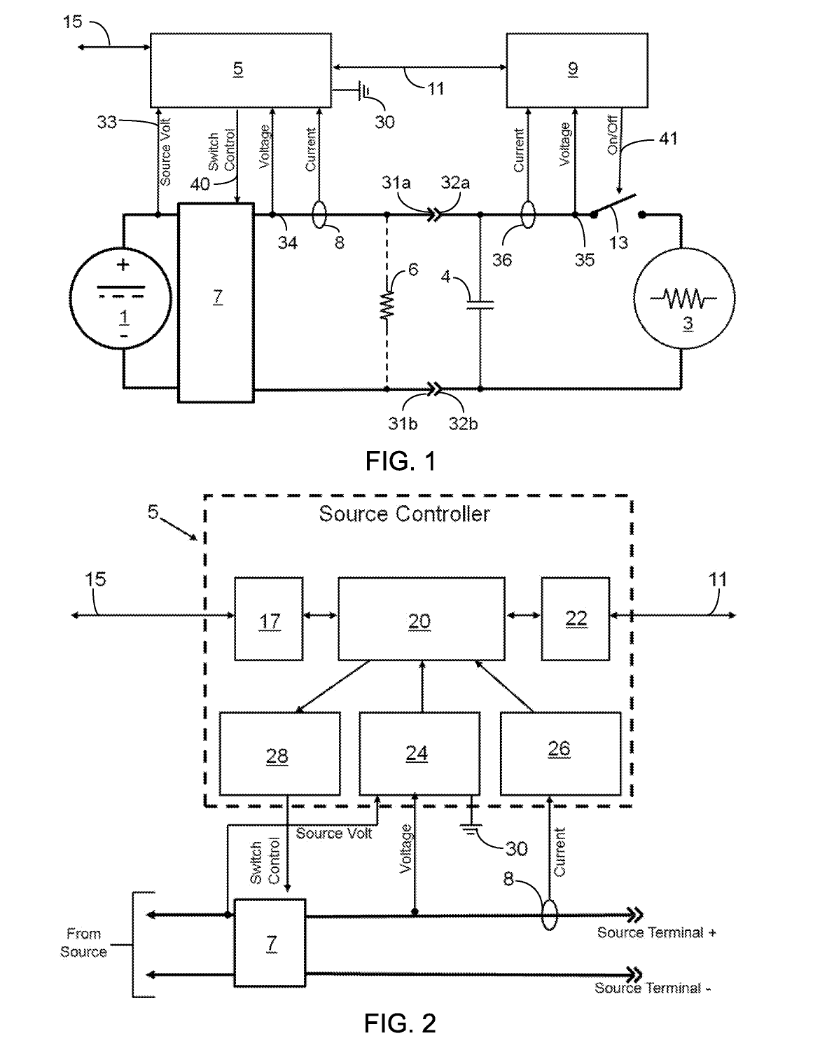

A block diagram of an embodiment of the power distribution system is shown in FIG. 1. The power distribution system regulates the transfer of energy from a source 1 to a load 3. Periodically, the source controller 5 operates a control signal 40 to reverse the polarity of the source terminals 31a and 31b relative to the source 1 using a switching bridge 7 for a predetermined time period, known as the “sample period”. During the sample period, the current sensor 8 is employed to measure the current on the transmission lines.

The normal resistance between the source terminals 31a and 31b is represented by R_{src}. In a particular embodiment, R_{src} has a value greater than 1 million Ohms. During normal conditions, when the polarity of the transmission lines is reversed, the current, as sensed by current sensor 8, would be less than 1 milliamp for a source voltage of 380V. However, during a cross-line fault, as depicted in FIG. 1 the resistance of a foreign object 6, such as a human body or conductive element, is introduced and is represented by Rₗₑₐₖ. The parallel combination of R_{src} and Rₗₑₐₖ will increase the current sensed by current sensor 8 significantly. If the current exceeds a predetermined maximum value, a fault is registered and the switching bridge 7 will be placed in a non-conducting state by the source controller 5, where the source 1 is electrically disconnected from the source terminals 31a and 31b.

If no fault conditions are detected, the switching bridge 7 is again commanded to a forward-polarity state. Energy is then transferred between the source 1 and the load 3 until the next sample period. The conducting period between sample periods is referred to as the “transfer period”.

An additional check for the in-line fault is where the source and load controllers 5 and 9 acquire their respective terminal voltages at sensing points 34 and 35, as shown in FIG. 1 during an energy transfer period. In embodiments incorporating advanced monitoring options, the communication link 11 would be implemented; and the source controller 5 would obtain the load terminal voltage through the communication link 11. The source controller 5 then calculates the voltage difference between the two measurements. The source controller 5 also acquires the electrical current passing through the source terminals 31a and 31b using a current sensor 8. The source controller 5 can now calculate the line resistance between the source and load terminals 31a/b and 32a/b using Ohm's law, or the relationship: Resistance=Voltage/Current. The calculated line resistance is compared to a predetermined maximum and minimum value. If the maximum is exceeded, switching bridge 7 will be placed in a non-conducting state and an in-line fault is registered. A line resistance that is lower than expected is also an indication of a hardware failure.

An alternative method to measure in-line resistance without a communications link 11 to the load 3 is where the source controller 5 measures the source terminal voltage at sensing point 34 and measures the electrical current passing through the source terminals 31a and 31b using the current sensor 8. The voltage and current samples are made nearly simultaneously during the same energy transfer period. The switching bridge 7 is then placed in a non-conducting state, and the source controller 5 immediately takes another voltage sample at sensing point 34. The difference in magnitude between the first and second voltage samples is proportional to the line resistance. Explained differently, as the transmission line resistance increases, more voltage is dropped across the length of the line for a given current. Since the voltage on the line capacitor 4 is equal to the source voltage minus the voltage drop on the line, measuring the voltage of the transmission lines without current flowing sets the line voltage drop to zero allowing an independent measurement of the voltage across the line capacitor 4. Once the voltage of the line capacitor 4 is known, the voltage drop on the transmission lines can be calculated by subtracting the earlier measurement at point 34 made when line current was present.

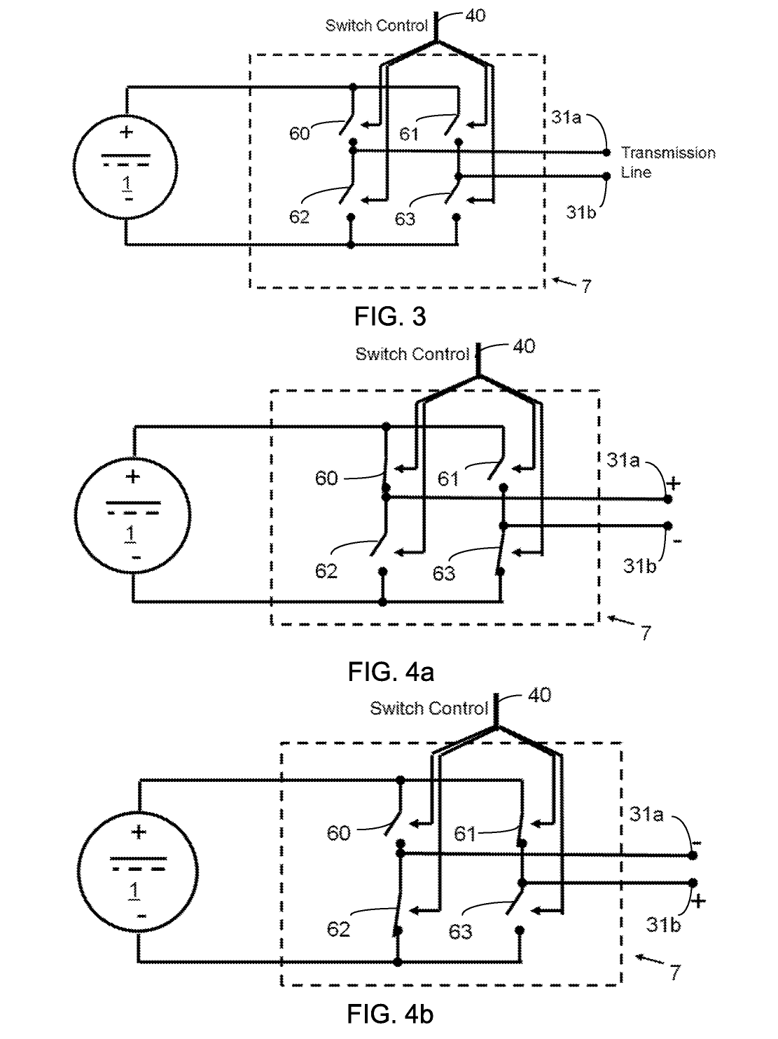

Referring to FIG. 3, the construction of the switching bridge 7 for the reversal of the transmission line voltage is accomplished in this embodiment using what is well known in the industry as a “full-bridge” converter. Switches 60, 61, 62, and 63 would typically be transistors. The transistor type is chosen based on the voltage and current requirements. Industry standard transistors that can be employed include field effect transistors (FETs), integrated gate bipolar transistors (IGBTs) or integrated gate commutated thyristors (IGCTs). The electrical implementation of the control signal 40 for controlling the conduction of the switches in the switching bridge 7 is dependent on the type of transistor but is well known to those skilled in the art of power electronics.

The switching bridge 7 has three states applicable to the present invention: non-conducting, forward-polarity (causes current to flow from the source 1 to the load 3) and reverse-polarity (where no current flows to the load 3 under normal operation). FIG. 3 depicts the non-conducting state since all four switches 60-63 are shown in an open or non-conducting state. In FIG. 4a, switches 60 and 63 are acted on by the control signal 40 to be conducting with the other switches 61 and 62 are in a non-conducting state, putting the switching bridge 7 into the forward-operating state. In FIG. 4b, switches 61 and 62 are acted on by control signal 40 to be conducting with the other switches 60 and 63 are in a non-conducting state, putting the switching bridge 7 into the reverse-polarity state.

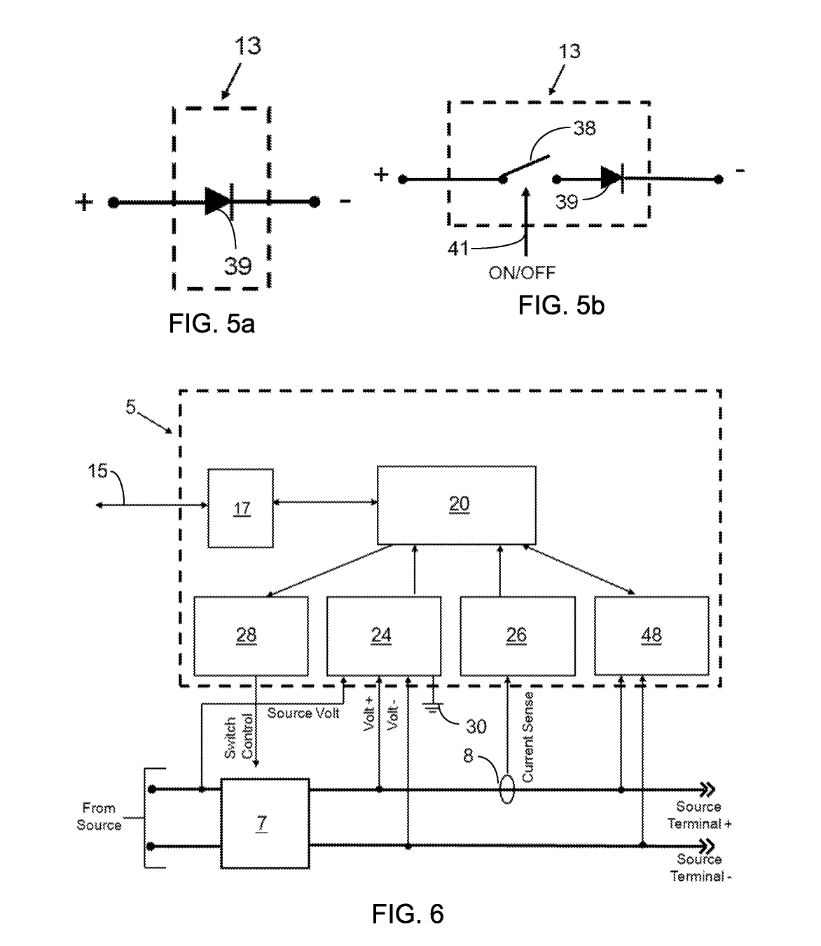

There are a number of industry standard methods for constructing the disconnect device 13 of FIG. 1. Referring to FIG. 5a, in cases where it is not necessary for the load controller 9 to have the ability to interrupt power to the load terminals 32a and 32b, internal switch 38 can be constructed using only diode 39 to block the back-flow of electrical current when the switching bridge 7 is in a non-conducting or reverse state. In an embodiment where the load controller 9 is configured to control the action of the disconnect device 13, an arrangement for a disconnect device 13, as shown in FIG. 5b can be used. In this arrangement, electrical current is blocked in the negative-to-positive direction by a blocking diode 39. Current flow in the positive-to-negative direction is controlled by an internal switch 38 according to the application of a control signal 41. The controllable switch 38 provides the capability for the load controller 9 to interrupt power in cases where an unauthorized source of power has been connected to the load terminals 32a and 32b or where the source controller 5 malfunctions and can no longer interrupt power from the source 1. In applications, such as battery charging, uncontrolled overcharging can result in battery damage or fire, thus making a controllable load disconnect switch 38 advantageous. Another advantage of using a controllable switch 38 is to implement what is well known to those skilled in the art as “synchronous” rectification, where the action of the switch 38 is controlled to emulate a diode. This provides the functionality of a diode but with higher efficiency, since a device, such as a field effect transistor, may be employed with lower conduction losses than a diode.

The transistor type used for the internal switch 38 is chosen based on the voltage and current requirements. Industry standard transistors that can be used include FETs, IGBTs or IGCTs. The electrical implementation of the control signal 41 for controlling the conduction of the internal switch 38 is dependent on the type of transistor but is well known to those skilled in the art of power electronics.

As shown in FIG. 2, the source controller 5 includes a microprocessor 20, communication drivers 17 and 22 and signal-conditioning circuits 24, 26, and 28. The load controller 9 of FIG. 1 is similar in construction to the source controller 5 but is configured with different operating software to perform the functions described in the operation sequence section, below. Referring to FIG. 1, before beginning operation, self-check and initialization steps are performed in steps (a), (b) and (c). The switching bridge 7 and the disconnect device 13 (if using a controllable switch 38) are commanded to remain in an open (non-conducting) state during initialization.

### II. Operational Sequence

Referring to FIG. 1, the source controller 5 verifies that the source voltage at point 33 is within a predetermined expected value and that there is no current flowing in the source power conductors, as reported by the current sensor 8. The source controller 5 also performs a built-in testing algorithm, as is typical in the industry, to verify that its hardware and firmware are functioning properly.
a) If the embodiment incorporates advanced monitoring options, a communication check is performed by the source controller 5 through the communication link 11 to the load controller 9. For distribution systems that provide secured energy transfer, the source controller 5 will expect a digital verification code that matches a predetermined value to ensure that the source and load equipment are electrically compatible and authorized to receive power before energy transfer is initiated. For example, a verification code may be utilized for applications where the energy is being purchased. The source controller 5 sends a request (e.g. via an electronic communication) via the communication link 11 to the load controller 9 asking it for its status. The load controller 9 responds (e.g. via another electronic communication) with the value of voltage and current on its conductors and any fault codes. The source controller 5 verifies that the load voltage is within a predetermined value and that there is no current flowing in the load power conductors (indicating a possible failed source disconnect, failed current sensors or other hardware problem). The load controller 9 also performs built-in testing algorithms, as is typical in the industry, to verify that its hardware and firmware are functioning properly. If there is no fault registered, the sequence progresses to step (c). If a fault is registered, the sequence is repeated starting at step (a).
b) The source controller 5 makes another measurement of the source voltage at point 33 to determine the duration of the transfer period, where energy will be transferred from the source 1 to the load 3. The higher the source voltage, the higher the potential fault current; and, hence, the shorter the transfer period. The source voltage measurement is applied to an internal table or function in the processor 20 of the source controller 5 to determine a safe duration value for the transfer period. The use of a variable transfer period is not required for the operation of the disclosed process but can make energy transfer more efficient and less prone to false alarms, since the number of measurements can be maximized and the amount of switching instances can be minimized according the length of the period. The alternative is to maintain a fixed duration transfer period that is configured for the highest possible source voltage and for the worst-case safety conditions.
c) Following the determination of the transfer period, the sample period begins. The source controller 5 acts to place the switching bridge 7 into the reverse-polarity state. If the load circuit 51 incorporates a controllable disconnect switch 38, the load controller 9 senses any reversal in current or decreases in voltage on the transmission lines when the voltage reverses and immediately opens the disconnect switch 13. No action is necessary from the load controller 9 if it is employing a diode 39 to perform the disconnect in the disconnect device 13.
d) Immediately after reversal, the source controller 5 measures the transmission line current using the current sensor 8. If the current value exceeds a predetermined maximum, a hardware fault is registered, and the switching bridge 7 is placed into the non-conducting state. The sequence skips to step (h). If there is no fault registered, the operational sequence continues to step (f).
e) Following the sample period, the source controller 5 acts to put the switching bridge 7 into a forward-polarity state. If the load circuit 51 incorporates a controllable disconnect switch 38, the load controller 9 will sense the rapid increase in voltage across the capacitor 4 measured by a voltage sensor at point 35 and immediately close the disconnect switch 38. No action is necessary if the load circuit 51 uses a diode 39 as a disconnect switch. Both controllers 5 and 9 continue to measure voltage and current at their respective terminals 31a and 31b and 32a and 32b.
f) The source controller 5 calculates the line resistance from the voltage and current samples acquired in steps (c), (d), and (e), using one of the two methods described herein. If there is no serial communication employed between the source and load controllers 5 an 9, the source controller 5 adds a small period where the switching bridge 7 is placed in a non-conducting state directly after the forward-conducting state in the transfer period. The difference in voltage at point 34 of FIG. 1 before and immediately after the switching bridge 7 is placed in the non-conducting state is divided by the current to calculate line resistance. If the source and load controller 5 and 9 are equipped with serial communications, the source controller 5 can request the load voltage reading from the load controller 9 to calculate the voltage difference between the source side and the load side. Dividing the voltage difference by current returns a value for line resistance. If the line resistance is greater than a predetermined maximum value, an in-line fault is registered by the source controller 5. A calculated line resistance less than a predetermined minimum value is indicative of a hardware failure. If a fault is registered, the source controller 5 immediately places the switching bridge 7 into a non-conducting state and proceeds to step (h). If there are no faults registered, the operational sequence repeats, starting at step (c).
g) The power distribution system is in a faulted state due to an in-line fault, cross-line fault or hardware failure. In particular embodiments, the system will allow configuration of either an automatic reset or manual reset from a faulted state. If the system is configured for manual reset, the switching bridge 7 will remain in a non-conducting state until an outside system or operator initiates a restart. The system will then restart the operational sequence from step (a). If the system is configured for automatic restart, then a delay period is executed by the source controller 5 to limit stress on equipment or personnel that may still be in contact with the power distribution conductors. In particular embodiments, the period is from 1 to 60 seconds. The system then restarts the operational sequence from step (a). For an additional level of safety, mechanical contactors may be included in series with the switching bridge 7 and/or with the disconnect switch 38 to act as redundant disconnects in the event that either the switching bridge 7 or the disconnect switch 38 has malfunctioned.

### III. Summary, Ramifications and Scope

The source controller 5 and the load controller 9 can include a logic device, such as a microprocessor, microcontroller, programmable logic device or other suitable digital circuitry for executing the control algorithm. The load controller 9 may take the form of a simple sensor node that collects data relevant to the load side of the system. It does not necessarily require a microprocessor.

The controllers 5 and 9 can be computing devices and the systems and methods of this disclosure can be implemented in a computing system environment. Examples of well-known computing system environments and components thereof that may be suitable for use with the systems and methods include, but are not limited to, personal computers, server computers, hand-held or laptop devices, tablet devices, smart phones, multiprocessor systems, microprocessor-based systems, set top boxes, programmable consumer electronics, network PCs, minicomputers, mainframe computers, distributed computing environments that include any of the above systems or devices, and the like. Typical computing system environments and their operations and components are described in many existing patents (e.g., U.S. Pat. No. 7,191,467, owned by Microsoft Corp.).

The methods may be carried out via non-transitory computer-executable instructions, such as program modules. Generally, program modules include routines, programs, objects, components, data structures, and so forth, that perform particular tasks or implement particular types of data. The methods may also be practiced in distributed computing environments where tasks are performed by remote processing devices that are linked through a communications network. In a distributed computing environment, program modules may be located in both local and remote computer storage media including memory storage devices.

The processes and functions described herein can be non-transitorially stored in the form of software instructions in the computer. Components of the computer may include, but are not limited to, a computer processor, a computer storage medium serving as memory, and a system bus that couples various system components including the memory to the computer processor. The system bus can be of any of several types of bus structures including a memory bus or memory controller, a peripheral bus, and a local bus using any of a variety of bus architectures.

The computer typically includes one or more a variety of computer-readable media accessible by the processor and including both volatile and nonvolatile media and removable and non-removable media. By way of example, computer-readable media can comprise computer-storage media and communication media.

The computer storage media can store the software and data in a non-transitory state and includes both volatile and nonvolatile, removable and non-removable media implemented in any method or technology for storage of software and data, such as computer-readable instructions, data structures, program modules or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can accessed and executed by the processor.

The memory includes computer-storage media in the form of volatile and/or nonvolatile memory such as read only memory (ROM) and random access memory (RAM). A basic input/output system (BIOS), containing the basic routines that help to transfer information between elements within the computer, such as during start-up, is typically stored in the ROM. The RAM typically contains data and/or program modules that are immediately accessible to and/or presently being operated on by the processor.

The computer may also include other removable/non-removable, volatile/nonvolatile computer-storage media, such as (a) a hard disk drive that reads from or writes to non-removable, nonvolatile magnetic media; (b) a magnetic disk drive that reads from or writes to a removable, nonvolatile magnetic disk; and (c) an optical disk drive that reads from or writes to a removable, nonvolatile optical disk such as a CD ROM or other optical medium. The computer-storage medium can be coupled with the system bus by a communication interface, wherein the interface can include, e.g., electrically conductive wires and/or fiber-optic pathways for transmitting digital or optical signals between components. Other removable/non-removable, volatile/nonvolatile computer storage media that can be used in the exemplary operating environment include magnetic tape cassettes, flash memory cards, digital versatile disks, digital video tape, solid state RAM, solid state ROM, and the like.

The drives and their associated computer-storage media provide storage of computer-readable instructions, data structures, program modules and other data for the computer. For example, a hard disk drive inside or external to the computer can store an operating system, application programs, and program data.

The source and load controllers 5 and 9 can be used to meter energy transfer and communicate the information back to the user or to a remote location. For example, the disclosed methods and system can be implemented on a public charging station for electric vehicles and can be utilized to send electricity consumption data back to a central credit card processor. The transfer of information can be through an outside communication link 15, as depicted in FIG. 1. A user can also be credited for electricity that is transferred from his electric vehicle and sold to the power grid. The outside communication link 15 can also be used to transfer other operational information. For example, an electric vehicle can have contacts under its chassis that drop down to make connection to a charging plate embedded in a road surface. The communication link 15 can transfer proximity information indicating that the car is over the charging plate. The information can inhibit energizing the charger plate unless the car is properly positioned.

The source switching bridge 7 can be supplemented by the addition of an electromechanical relay or “contactor” providing a redundant method to disconnect the source 1 from the source terminals so as to provide a back-up in the case of a failure of the source switching bridge 7. The load disconnect device 13 can be supplemented by an electromechanical relay or contactor in the same fashion. The electromechanical contactor activation coils can be powered by what is known to those skilled in the art as a “watchdog circuit”. The watchdog circuit continually communicates with the source or load controllers 5 and 9; otherwise, the contactor will automatically open, providing a fail-safe measure against “frozen” software or damaged circuitry in the controllers 5 and 9.

Referring to FIG. 3, one or both of switches 61 and 62 can be low-current, high-resistance switches or can include a current-limiting series-resistor. This is due to the fact that these switches are active only during the reverse-conducting state of the switching bridge 7, where minimum current is expected to flow under normal conditions. If a fault is experienced that does draw significant current, much of the source voltage will be dropped across the switch 61/62 or series-resistor. Thus, an indicator of fault current can be determined by simply measuring the voltage at point 34 of FIG. 1 and registering a fault if the voltage is more than a predetermined value less than the source voltage.

An alternative embodiment of a combined load and load disconnect device 13 is shown in FIG. 8. In this embodiment, a series string of uni-directional switching devices—in this case, light emitting diodes 70, 72, 74, and 76—are combined in parallel with resistors 71, 73, 75, and 77. When the switching bridge 7 is in the forward-polarity state, current flows freely through the diodes 70, 72, 74, and 76. When the switching bridge 7 is in the reverse-polarity state, electric current is blocked by the diodes 70, 72, 74, and 76; but a limited amount is allowed to flow in parallel resistors 71, 73, 75 and, 77. If there is a fault within the load disconnect device 13, represented by fault resistor (R fault) 78, the parallel combination of R fault, fault 78 and resistors 71, 73, 75, and 77 will cause an increase in current during the time when the switching bridge 7 is in the reverse-polarity state. If the current exceeds a predetermined value, a fault is registered and the source controller 5 acts to place the switching bridge 7 into a non-conducting state to disconnect the source 1 from the source terminals 31a and 31b. Alternatively, a measurable decrease in current can indicate a damaged load disconnect device 13 and the source controller 5 would again register a fault and place the switching bridge 7 into a non-conducting state.

The data communication link 11 and/or external communication link 15 can be implemented using various methods and protocols well known to those skilled in the art. Communication hardware and protocols can include RS-232, RS-485, CAN bus, Firewire and others. The communication link 11 can be established using copper conductors, fiber optics or wirelessly over any area of the electromagnetic spectrum allowed by regulators, such as the Federal Communications Commission (FCC), as set forth in Part 18 of the FCC rules—for example, the 2.4 GHz, 3.6 GHz, 4.9 GHz, 5 GHz, and 5.9 GHz frequencies allocated for WiFi or the 915 Mhz frequency allocated for ZigBee. Wireless communication can be established using any of a number of protocols well known to those skilled in the art, including Wi-Fi, ZigBee, IRDa, Wi-Max and others. The data communication link 11 and/or external communication link 15 of FIG. 1 can be what is referred to by those skilled in the art as “communication over power lines”, or “communication or power line carrier” (PLC), also known as “power line digital subscriber line” (PDSL), “mains communication”, or “broadband over power lines” (BPL). Referring to the revised source controller of FIG. 6, communication signals generated by a microprocessor 20 are superimposed on the source terminals 31a and 31b using a modulator/demodulator 48. The hardware and software methods of the modulator/demodulator 48 are well known to those skilled in the art. Although the source controller 5 is used as an example, an identical implementation of the modulator/demodulator 48 can be contained in the load controller 9, allowing bidirectional communication between the source and load controllers 5 and 9. The transmitting side, either the source 1 or load 3, combines the communication signals with the power waveform on the source or load terminals 31a and 31b or 32a and 32b. The receiving side, either the source 1 or the load 3, would then separate the communication signals from the power waveform.

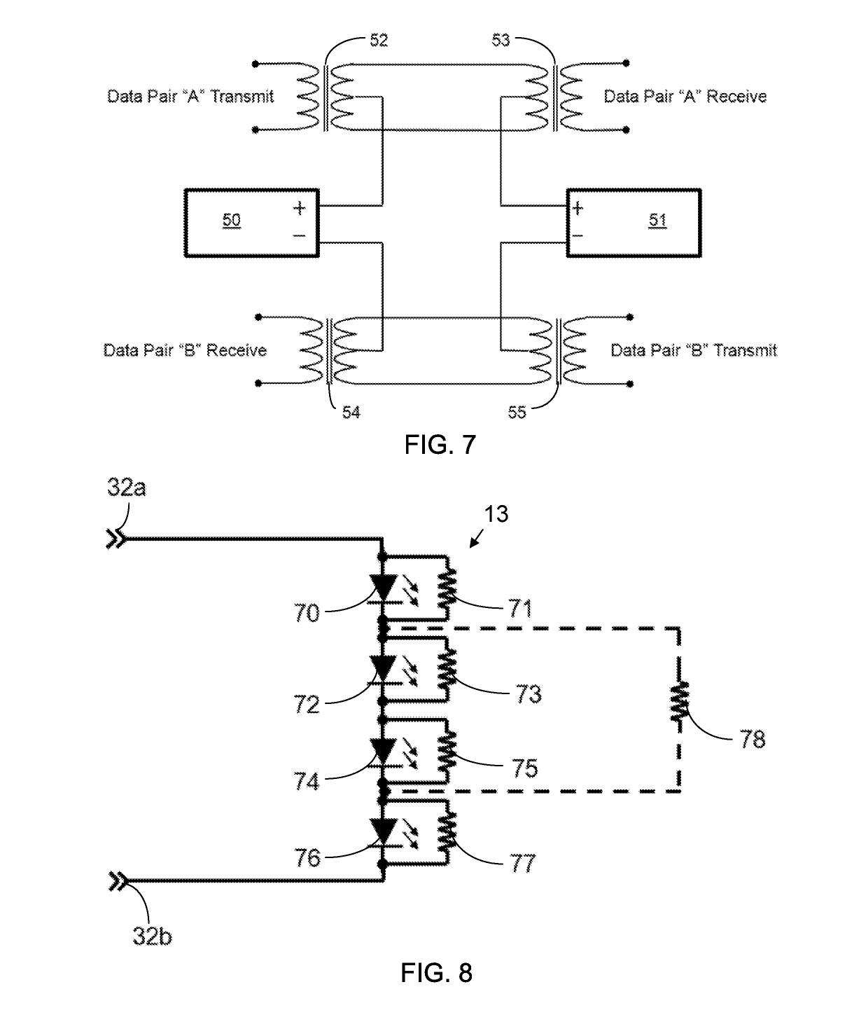

To allow simultaneous power transfer and user-data communications, the system can be configured as depicted in FIG. 7. In one example, a CAT 5 communication cable is used to transfer ethernet data between an end-user's computer and an ethernet switch; and the same cable conductors can be used to provide 400-600 Watts of power to the computer, itself, using the methods described herein. Referring to FIG. 7, the source circuitry 50 can include all of the source components; or, referring to FIG. 1, the source circuitry 50 can include the source 1, the source controller 5, the switching bridge 7, and all related source components. The load circuitry 51, shown in FIG. 7, can represent all of the load components; or, referring to FIG. 1, the load circuitry 51 can include the load 3, the load controller 9, the load disconnect device 13, and all related load components. The output conductors of the source circuitry 50 are applied to the center tap points of isolation transformers 52 and 54 on the source side of the configuration. Corresponding center tap points on isolation transformers 53 and 55 are on the load side of the configuration and are electrically connected to center points on transformers 52 and 54 through the transformer windings. On the source side, ethernet data can be applied to the windings of transformers 52 and 54 that are electrically isolated from the center-tapped side using a balanced conductor pair configuration that is well known to those in the industry. On the load side, the pairs are picked up on the corresponding windings of the transformers 53 and 55 that are electrically isolated from the center-tapped side containing the power. Because the power is essentially direct current, it passes through the transformers 52 and 54 on the source side to the load side without causing magnetic excitation and, therefore, does not corrupt the data that is also resident on the communication lines. The described hardware configuration of center-tapped transformers is commonly used in the industry for implementing power over ethernet (PoE) as is described in PoE standard IEEE-802.3a. PoE does not have the safety features, described herein, and is therefore limited to approximately 48V to avoid the possibility of electrical shock.

Thus the scope of the disclosed invention should be determined by the appended claims and their legal equivalents, rather than the examples given. In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. Still further, the components, steps and features identified in the Background section are integral to this disclosure and can be used in conjunction with or substituted for components and steps described elsewhere in the disclosure within the scope of the invention. In method claims, where stages are recited in a particular order—with or without sequenced prefacing characters added for ease of reference—the stages are not to be interpreted as being temporally limited to the order in which they are recited unless otherwise specified or implied by the terms and phrasing.

I claim:

1. A power distribution system for regulating transfer of energy from a source on a source side and including source terminals to a load on a load side and including load terminals, the system comprising:
a) a source controller on the source side of the power distribution system in communication with and responsive to a source sensor that provides feedback to the source controller that includes at least a signal indicative of electric current through the source terminals;
b) a source switching bridge electrically coupled with the source controller and responsive to control signals from the source controller for electrically disconnecting the source from the source terminals and for applying a source voltage in either a forward-polarity or reverse-polarity state relative to the source terminals;
c) a load disconnect device configured to electrically decouple the load from the load terminals; and
d) a logic device implemented in at least the source controller and configured to place the source switching bridge into a reverse-polarity state and to perform at least one current measurement on the current passing through the source terminals when the source switching bridge is in the reverse-polarity state, wherein a current measurement outside of predetermined high or low limits indicates that there is a foreign object or living organism making contact with the source or load terminals or a failure in the power distribution system, and to electrically disconnect the source from the source terminals if the current measurement falls outside the predetermined high and low limits.

2. The power distribution system of claim 1, further comprising a load controller on the load side of the power distribution system in communication with and responsive to a load sensor that provides feedback to the load controller, wherein the feedback includes at least a signal indicative of a voltage across the load terminals.

3. The power distribution system of claim 2, further comprising a data communication link configured for exchange of operating information between the source controller and the load controller, wherein the operating information includes at least a value indicative of the voltage across the load terminals that is acquired by the load controller.

4. The power distribution system of claim 3, wherein the data communication link comprises wireless communication circuits configured for operation at carrier frequencies within an electromagnetic spectrum allowed by federal regulators.

5. The power distribution system of claim 3, wherein the source and load controllers each include a modem configured to exchange the operation information and operable to combine a communication signal with voltage waveforms present on the source or load terminals and to later separate the communication signal from the voltage waveforms present on the source or load terminals, such that the source and load controllers can communicate with each other using only connections between the source and load terminals.

6. The power distribution system of claim 5, wherein the source and load controllers are configured to initiate exchange of operating information only when the source is disconnected from the source terminals so as to interrupt, when operating information is exchanged, current flow from the source terminals to the load terminals and associated electrical noise generated by the current.

7. The power distribution system of claim 3, wherein the source and load controllers each include a processor in communication with a computer-readable medium non-transitorily storing software code for exchanging a digital verification code that must match a predetermined value before energy transfer can be initiated and a communication driver configured to exchange the digital verification code.

8. The power distribution system of claim 2, wherein the power distribution system further comprises a source disconnect device configured to electrically decouple the source from the source terminals, wherein the source controller is configured to calculate a difference between a source terminal voltage acquired by the source controller and the load terminal voltage acquired by the load controller and to issue a command to open the source disconnect device if the difference does not fall between predetermined high and low values.

9. The power distribution system of claim 1, wherein the power distribution system further comprises a source disconnect device configured to electrically decouple the source from the source terminals, wherein the source disconnect device is configured to respond to a control signal from the source controller to vary the ratio of time that the source is connected to the source terminals in relationship to the time the source is disconnected from the source terminals so as to regulate the average energy transferred from the source to the load.

10. The power distribution system of claim 1, further comprising a voltage sensor that allows the source controller to acquire a signal indicative of the electrical voltage at the source terminals, wherein the source controller is configured to disconnect the source from the source terminals if the electrical voltage is outside of predetermined high or low limits.

11. The power distribution system of claim 10, wherein the source controller is configured to periodically multiply source terminal voltage measurements with the source current measurements resulting in a calculated instantaneous power value and to integrate consecutive power values to derive a total energy value.

12. The power distribution system of claim 11, wherein the source controller is also configured to apply a financial charge to a user for energy extracted from the source.

13. The power distribution system of claim 1, wherein the load disconnect device comprises a diode.

14. The power distribution system of claim 1, wherein the load and load disconnect device comprises a series string of uni-directional current conducting devices with parallel connected resistors, wherein the uni-directional devices are configured to allow current flow when the source switching bridge is in the forward-polarity state and where the resistors allow a limited amount of current to flow around the uni-directional devices when the source switching bridge is in the reverse conducting state, and where the source controller is configured to measure the current flow during the reverse-polarity state and will disconnect the source from the source terminals if the current measurement is outside of predetermined high or low limits.

15. A method for implementing a power distribution system for a transfer of energy from a source to a load, where the power distribution system is configured to detect unsafe conditions that include electrically conducting foreign objects or individuals that have come in contact with exposed conductors in the power distribution system, the method comprising the steps of:
a) generating a responsive signal in a source controller including source terminals, the responsive signal reversing a voltage on the source terminals;
b) with the voltage on the source terminals reversed, acquiring a measurement of electrical current flowing through the source terminals; and
c) generating signals from the source controller to electrically disconnect the source from the source terminals if and when the electrical current falls outside of high or low limits indicating that there is a conducting foreign object or living organism making electrical contact with the source or load terminals or a failure in power distribution system hardware.

16. The method of claim 15, wherein the source controller communicates with a load controller using at least one of an optical, conductive and wireless communication link.

17. The method of claim 15, wherein the source controller acquires a digital verification code from a load controller via a communication link and acts to cause the source to electrically disconnect from the source terminals if the digital verification code does not match a previously stored code resident in memory of the source controller.

18. The method of claim 15, wherein the source controller acts to vary a forward-polarity time period of the source switching bridge in relation to the time where the source switching bridge is in a reverse-polarity state or where the source is disconnected from the source terminals such that the average energy transferred from the source to the load can be regulated according to an algorithm being executed by the source controller.

19. The method of claim 15, further comprising:
f) executing code in the source controller to acquire a measurement of the electrical current flowing through the source terminals using a current sensor;
g) storing the electrical current value in a computer-readable storage device in the source controller; and
h) opening a source disconnect device to disconnect the source from the source terminals if and when the electrical current exceeds a predetermined maximum value.

20. The method of claim 15, further comprising executing an algorithm in the source controller to calculate a difference between the source terminal voltage acquired by the source controller using a source terminal voltage sensor and a load terminal voltage acquired by the source controller from a load controller and opening a source disconnect device if and when the difference between the source terminal voltage and the load terminal voltage does not fall between predetermined high and low limits.

21. The method of claim 15, further comprising, at the source controller:
f) acquiring a measurement of the electrical current flowing through the source terminals using a current sensor;
g) acquiring a measurement of the source terminal voltage using a voltage sensor;
h) periodically multiplying the source terminal voltage measurements by the source current measurements to derive an instantaneous power value; and
i) integrating consecutive calculated power values with respect to time to derive a total energy value.

22. The method of claim 21, further comprising applying a financial charge to a user of the energy for energy extracted by the user from the source.

23. The method of claim 15, wherein the source controller acquires a first measurement of the source terminal voltage using a voltage sensor while the source switching bridge is in a forward-polarity state and a second measurement of the source terminal voltage immediately after the source switching bridge electrically disconnects the source from the source terminals, and computes a difference between the first and second source terminal voltage measurements, and where the source controller takes action to electrically disconnect the source from the source terminals if the source terminal voltage difference falls outside of predetermined high or low limits.

24. The method of claim 23, wherein the source controller also acquires a measurement of the electrical current flowing through the source terminals using a current sensor while the source switching bridge is in the forward-polarity state and divides the source terminal voltage difference by the electrical current measurement to derive a value for a resistance of the conductors between the source terminals and the load terminals, and where the source controller takes action to open the source disconnect if the resistance value falls outside of predetermined high and low limits.

25. The method of claim 15, further comprising connecting a first source circuitry output conductor to a center tap point on a secondary coil of a first isolation transformer and connecting a second source circuitry output conductor to a center tap point on a secondary coil of a second isolation transformer, where a first load circuitry input conductor is connected to a center tap point on a primary coil of a third isolation transformer and a second load circuitry input conductor is connected to a center tap point of a primary coil on a fourth isolation transformer, such that the configuration substantially cancels any flux produced in the four transformers due to current flowing from the source circuitry to the load circuitry, and where the remaining unused terminals of the four transformers can be used to transmit and receive data that is electrically isolated and independent of electrical current flowing from the source circuitry to the load circuitry.

26. The method of claim 25, wherein the data is communicated using Ethernet technology.

27. The method of claim 25, wherein the data is communicated using digital subscriber line technology.
